(19) United States
(12) Patent Application Publication
(10) Pub. No.: US 2021/0149038 A1
(43) Pub. Date: May 20, 2021

(54) RADAR DEVICE

(71) Applicant: Murata Manufacturing Co., Ltd., Kyoto (JP)

(72) Inventors: Atsuyuki YUASA, Kyoto (JP); Katsuhisa KASHIWAGI, Kyoto (JP)

(21) Appl. No.: 17/161,891

(22) Filed: Jan. 29, 2021

Related U.S. Application Data
(63) Continuation of application No. PCT/JP2019/029015, filed on Jul. 24, 2019.

(30) Foreign Application Priority Data
Jul. 31, 2018 (JP) 2018-143794

(51) Int. Cl. G01S 13/44; G01S 7/35

(52) U.S. Cl. CPC G01S 13/4409; G01S 7/354; G01S 13/4463

(57) ABSTRACT

A radar device includes plural transmit antennas, plural receive antennas, a local oscillator that oscillates a local signal, a transmit processor that sends transmit signals based on the local signal from the transmit antennas, a receive processor that outputs beat signals from the local signal and echo signals generated as a result of the transmit signals being reflected by a target and received by the receive antennas, and a signal processor that executes signal processing on the beat signals. The transmit processor sends the transmit signals from the plural transmit antennas at different timings and also simultaneously sends the transmit signals which are combinable with each other from the plural transmit antennas.

### CROSS REFERENCE TO RELATED APPLICATION

This is a continuation of International Application No. PCT/2019/029015 filed on Jul. 24, 2019 which claims priority from Japanese Patent Application No. 2018-143794 filed on Jul. 31, 2018. The contents of these applications are incorporated herein by reference in their entireties.

### BACKGROUND

### Technical Field

The present disclosure relates to a radar device that measures the distance to a target and finds the direction of the target, for example.

A MIMO (Multiple-Input Multiple-Output) radar device including plural transmit antennas and plural receive antennas is known (Patent Document 1). Radio waves radiated from the transmit antennas are reflected by a target to be detected. The radar device receives the reflected waves by using the plural receive antennas at the same time and detects the phase difference between the reflected waves received by the individual receive antennas. The MIMO radar device can find the orientation (direction) of the target by calculations in this manner.

The MIMO radar device sends radio waves by sequentially switching the transmit antennas whose phase centers are different from each other. The MIMO radar device receives reflected waves generated by the reflection of radio waves sent from the different transmit antennas. The signals received by the receive antennas are out of phase by the amount of a phase difference between the phase centers of the transmit antennas. By combining these received signals, a virtual array antenna can be constructed in which the maximum number of receive antennas, which is determined by the product of the number of transmit circuits (transmit antennas) and that of receive circuits (receive antennas), is greater than the actual number of antennas. As a result, the angular resolution can be enhanced.

Patent Document 1: Japanese Unexamined Patent Application Publication (Translation of PCT Application) No. 2017-534881

### BRIEF SUMMARY

In the radar device disclosed in Patent Document 1, the maximum number of receive antennas of a virtual array antenna is determined by the product of the number of transmit antennas and that of receive antennas. To further enhance the angular resolution, it is thus necessary to provide more transmit antennas or more receive antennas. This increases the complexity of the circuit configuration and the manufacturing cost.

The present disclosure has been made to solve the above-described problem of the related art. The present disclosure provides a radar device that can exhibit a high angular resolution with a simple configuration.

The present disclosure provides a radar device including plural transmit antennas, at least one receive antenna, a local oscillator that oscillates a local signal, a transmit processor that sends transmit signals based on the local signal from the transmit antennas, a receive processor that outputs beat signals from the local signal and echo signals generated as a result of the transmit signals being reflected by a target and received by the at least one receive antenna, and a signal processor that executes signal processing on the beat signals. The transmit processor sends the transmit signals which are separable from each other from the plural transmit antennas and also simultaneously sends the transmit signals which are combinable with each other from the plural transmit antennas.

According to the present disclosure, it is possible to obtain a high angular resolution with a simple configuration.

### BRIEF DESCRIPTION OF THE SEVERAL VIEWS OF THE DRAWINGS

FIG. 1 is a block diagram illustrating a radar device according to a first embodiment of the present disclosure.

FIG. 2 is a characteristic diagram illustrating a time change in a transmit signal, an echo signal, and a beat signal.

FIG. 3 is a diagram for explaining target direction finding by using a virtual array antenna.

FIG. 4 is a characteristic diagram illustrating a time change in transmit signals output from two transmit antennas.

FIG. 5 is a flowchart illustrating direction finding processing executed by a signal processor shown in FIG. 1.

FIG. 6 is a block diagram illustrating a radar device according to a second embodiment of the present disclosure.

FIG. 7 is a block diagram illustrating a radar device according to a third embodiment of the present disclosure.

FIG. 8 is a flowchart illustrating direction finding processing executed by a signal processor shown in FIG. 7.

### DETAILED DESCRIPTION

Radar devices according to embodiments of the present disclosure will be described below in detail with reference to the accompanying drawings.

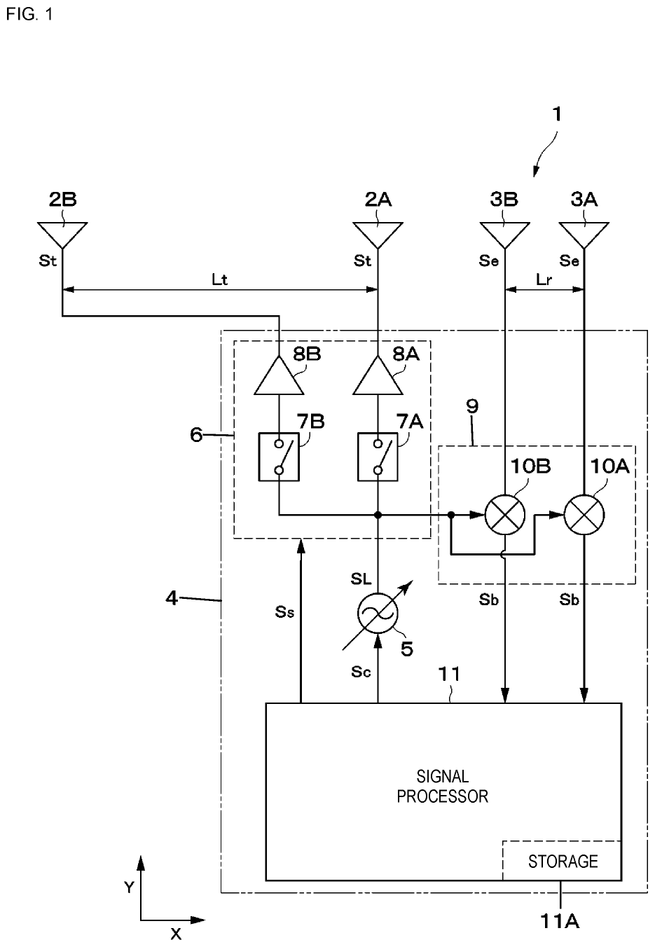

FIG. 1 illustrates a radar device 1 according to a first embodiment of the present disclosure. The radar device 1 is a TDMA (Time Division Multiple Access) FMCW (Frequency Modulated Continuous Wave) MIMO (Multiple-Input Multiple-Output) radar device.

The radar device 1 includes transmit antennas 2A and 2B, receive antennas 3A and 3B, and a radar-signal processing IC 4. The transmit antennas 2A and 2B, the receive antennas 3A and 3B, and the radar-signal processing IC 4 are disposed on a printed board (not shown), for example.

The transmit antennas 2A and 2B, each radiates a local signal SL output from a transmit processor 6 into the air as a transmit signal St. FIG. 1 illustrates an example of the radar device 1 including the two transmit antennas 2A and 2B. The transmit antennas 2A and 2B are disposed with a predetermined spacing Lt therebetween in the X direction. The spacing Lt is set to be a value (2λ) twice as long as the wavelength λ of the transmit signal St, for example. The number of switches 7A and 7B and that of power amplifiers 8A and 8B of the transmit processor 6 match the number of transmit antennas 2A and 2B. The number of transmit antennas 2A and 2B is not restricted to two, and three or more transmit antennas may be provided.

The receive antennas 3A and 3B, each receives an echo signal Se generated as a result of the transmit signal St being reflected by a target and returned from the target. FIG. 1 illustrates an example of the radar device 1 including the two receive antennas 3A and 3B. The receive antennas 3A and 3B are displaced from the transmit antennas 2A and 2B toward one side (right side in FIG. 1) in the X direction. The receive antennas 3A and 3B are disposed with a predetermined spacing Lr therebetween in the X direction. The spacing Lr is set to be a value (0.5λ), which is half the wavelength λ of the transmit signal St, for example. In this case, the spacing Lr is set to be smaller than half the spacing Lt, for example. The number of receive antennas 3A and 3B is not limited to two, and one or three or more receive antennas may be provided.

In FIG. 1, the transmit antennas 2A and 2B and the receive antennas 3A and 3B are aligned in the X direction. However, this arrangement is only an example, and the transmit antennas 2A and 2B and the receive antennas 3A and 3B may be displaced from each other in the Y direction, which is perpendicular to the X direction.

The radar-signal processing IC 4 includes a local oscillator 5, the transmit processor 6, a receive processor 9, and a signal processor 11.

The local oscillator 5 oscillates a local signal SL. More specifically, the local oscillator 5 outputs a local signal SL having a chirp waveform in which the frequency linearly increases or decreases with time, based on a chirp control signal Sc output from the signal processor 11. The local oscillator 5 outputs the generated local signal SL to the transmit processor 6 and the receive processor 9.

The transmit processor 6 transmits the local signal SL output from the local oscillator 5 from the antennas 2A and 2B as transmit signals St. The transmit processor 6 includes the switches 7A and 7B and the power amplifiers 8A and 8B. The switches 7A and 7B are turned ON or OFF based on a switching control signal Ss output from the signal processor 11. When the switches 7A and 7B are ON, the local signal SL is sent to the power amplifiers 8A and 8B. The power amplifiers 8A and 8B amplify power of the local signal SL sent from the local oscillator 5 and outputs the amplified local signal SL to the transmit antennas 2A and 2B, respectively.

When the switch 7A is ON and the switch 7B is OFF, only the transmit antenna 2A sends the transmit signal St. When the switch 7B is ON and the switch 7A is OFF, only the transmit antenna 2B sends the transmit signal St. When the switches 7A and 7B are both ON, the transmit antennas 2A and 2B send the transmit signals St at the same time.

The receive processor 9 outputs beat signals Sb from the local signal SL and the echo signals Se generated as a result of the transmit signals St being reflected by a target and received by the receive antennas 3A and 3B. More specifically, the receive processor 9 generates beat signals Sb by multiplying the echo signals Se received by the receive antennas 3A and 3B and the local signal SL output from the local oscillator 5 by each other. The receive processor 9 includes mixers 10A and 10B, each multiplies the echo signal Se by the local signal SL.

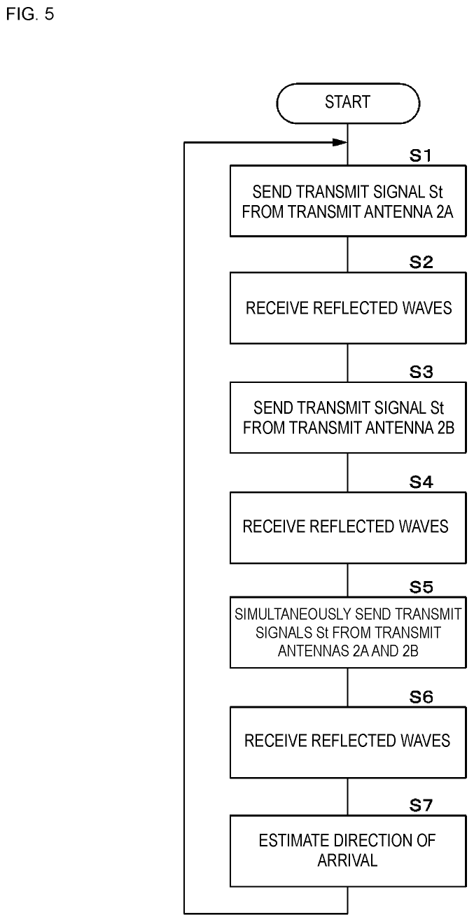

The signal processor 11 executes signal processing on the beat signals Sb. The signal processor 11 includes an AD converter, an FFT, and a microcomputer, for example. The signal processor 11 also includes a storage 11A. In the storage 11A, a program for direction finding processing shown in FIG. 5 is stored. The signal processor 11 executes this program stored in the storage 11A. The storage 11A stores beat signals Sb generated in the following cases in which: a transmit signal St is sent from the transmit antenna 2A; a transmit signal St is sent from the transmit antenna 2B; and transmit signals St are simultaneously sent from the transmit antennas 2A and 2B.

The signal processor 11 outputs the chirp control signal Sc to the local oscillator 5. The signal processor 11 outputs the switching control signal Ss, which controls the outputting of the transmit signal St, to the transmit processor 6. The signal processor 11 also measures the distance to a target (ranging) and finds the direction of the target by using the beat signals Sb output from the receive processor 9.

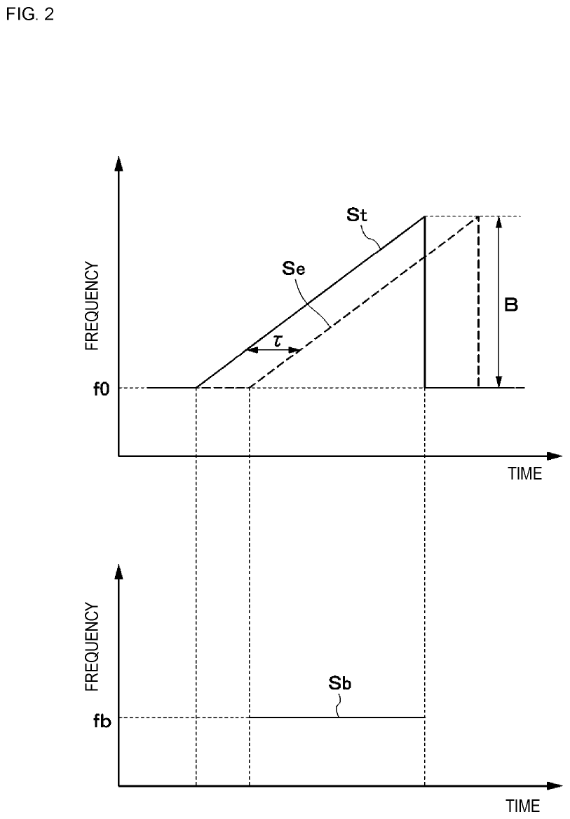

Target ranging performed by the signal processor 11 will be discussed below with reference to FIG. 2. As shown in FIG. 2, the frequency of the transmit signal St linearly increases from f0 to f0+B with time. The echo signal Se is delayed by a time τ from when the transmit signal St is sent until when it is reflected by and returned from a target. The frequency fb of the beat signal Sb is proportional to this time τ. The signal processor 11 thus measures the distance to the target by detecting the frequency fb of the beat signal Sb.

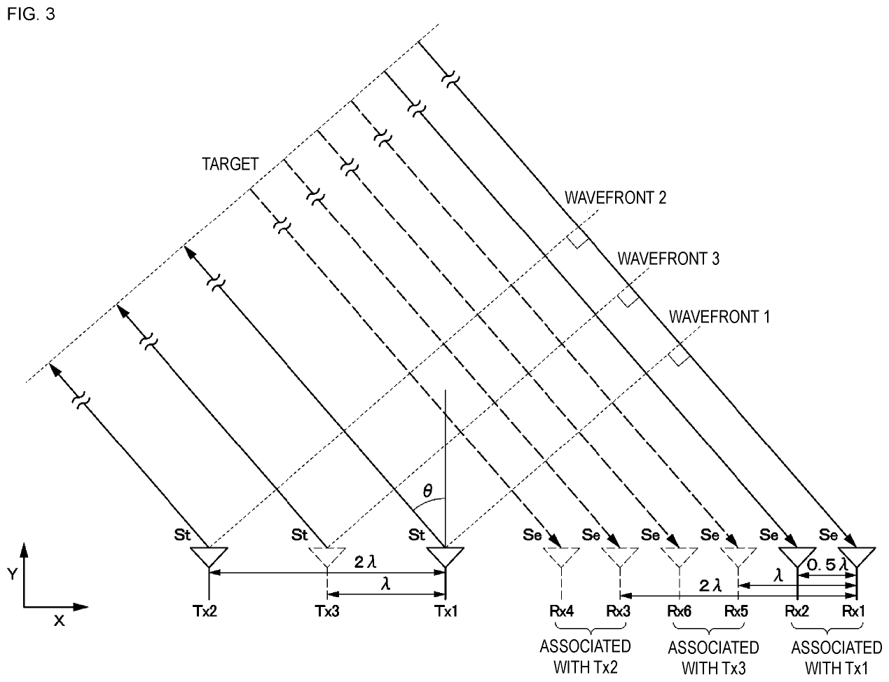

Target direction finding performed by the signal processor 11 will be discussed below with reference to FIG. 3. FIG. 3 shows an example in which a target is located in a direction at the angle θ with respect to the Y direction, which is perpendicular to the X direction. In this case, the angle θ corresponds to the direction of arrival of echo signals Se. In FIG. 3, virtual transmit antennas Tx1, Tx2, and Tx3 and virtual receive antennas Rx1, Rx2, Rx3, Rx4, Rx5, and Rx6 are shown.

The virtual transmit antenna Tx1 and the virtual receive antennas Rx1 and Rx2 correspond to the transmit antenna 2A and the receive antennas 3A and 3B when a transmit signal St is sent from the transmit antenna 2A. The virtual transmit antenna Tx2 and the virtual receive antennas Rx3 and Rx4 correspond to the transmit antenna 2B and the receive antennas 3A and 3B when a transmit signal St is sent from the transmit antenna 2B. The virtual transmit antenna Tx3 and the virtual receive antennas Rx5 and Rx6 correspond to the transmit antennas 2A and 2B and the receive antennas 3A and 3B when in-phase transmit signals St are simultaneously sent from the transmit antennas 2A and 2B.

In FIG. 3, for the sake of description, the target is located near the transmit antennas Tx1, Tx2, and Tx3 and the receive antennas Rx1, Rx2, Rx3, Rx4, Rx5, and Rx6. In actuality, however, the target is located at a sufficiently remote position with respect to the wavelength λ of the band (GHz band, for example) used for the local signal SL, such as at a remote position which is 100 times or more as long as the wavelength λ. Hence, propagation of electromagnetic waves between the target and the transmit antennas Tx1, Tx2, and Tx3 and the receive antennas Rx1, Rx2, Rx3, Rx4, Rx5, and Rx6 can approximate to the propagation of a plane wave.

When a transmit signal St is sent from the transmit antenna 2A, the phase center of the transmit signal St is the position at which the transmit antenna 2A is located. This is equivalent to the configuration in which the virtual transmit antenna Tx1 is disposed at the position of the transmit antenna 2A. The transmit signal St propagates from the wavefront 1 corresponding to the virtual transmit antenna Tx1 to the target. The echo signal Se returned from the target propagates to the receive antennas 3A and 3B.

Then, when a transmit signal St is sent from the transmit antenna 2B, the phase center of the transmit signal St is the position at which the transmit antenna 2B is located. This is equivalent to the configuration in which the virtual transmit antenna Tx2 is disposed at the position of the transmit antenna 2B. The transmit signal St propagates from the wavefront 2 corresponding to the virtual transmit antenna Tx2 to the target. The echo signal Se returned from the target propagates to the receive antennas 3A and 3B. When the transmit signal St is sent from the transmit antenna 2B, the propagation distance to the target becomes shorter than that when the transmit signal St is sent from the transmit antenna 2A by the amount of the distance between the wavefront 1 and the wavefront 2.

Additionally, when in-phase transmit signals St are simultaneously sent from the transmit antennas 2A and 2B, the phase centers of the transmit signals St are positioned at the center between the transmit antennas 2A and 2B. This is equivalent to the configuration in which the virtual transmit antenna Tx3 is disposed at the center between the transmit antennas 2A and 2B. The transmit signal St propagates from the wavefront 3 corresponding to the virtual transmit antenna Tx3 to the target. The echo signal Se returned from the target propagates to the receive antennas 3A and 3B. When the transmit signal St is sent from the virtual transmit antenna Tx3, the propagation distance to the target becomes shorter than that when the transmit signal St is sent from the transmit antenna 2A by the amount of the distance between the wavefront 1 and the wavefront 3.

FIG. 3 is a diagram for explaining target direction finding by using a virtual array antenna. The distance between the wavefront 1 and the wavefront 2 is the same as the difference between the propagation distance to the virtual receive antenna Rx1 and that to the virtual receive antenna Rx3. That is, the situation where a transmit signal St is sent from the transmit antenna 2B is equivalent to that where a transmit signal St is sent from the transmit antenna 2A and reflected signals are received by the virtual receive antennas Rx3 and Rx4. Additionally, the situation where transmit signals St are simultaneously sent from the transmit antennas 2A and 2B is equivalent to that where a transmit signal St is sent from the transmit antenna 2A and reflected signals are received by the virtual receive antennas Rx5 and Rx6. Hence, with the transmission from the transmit antennas 2A and 2B, a virtual array antenna constituted by receive antennas Rx1, Rx2, Rx3, Rx4, Rx5, and Rx6 can be constructed. The receive antennas Rx5 and Rx6 are disposed between the receive antennas Rx1 and Rx2 and the receive antennas Rx3 and Rx4.

Target direction finding processing executed by the signal processor 11 will be described below with reference to FIGS. 3 through 5.

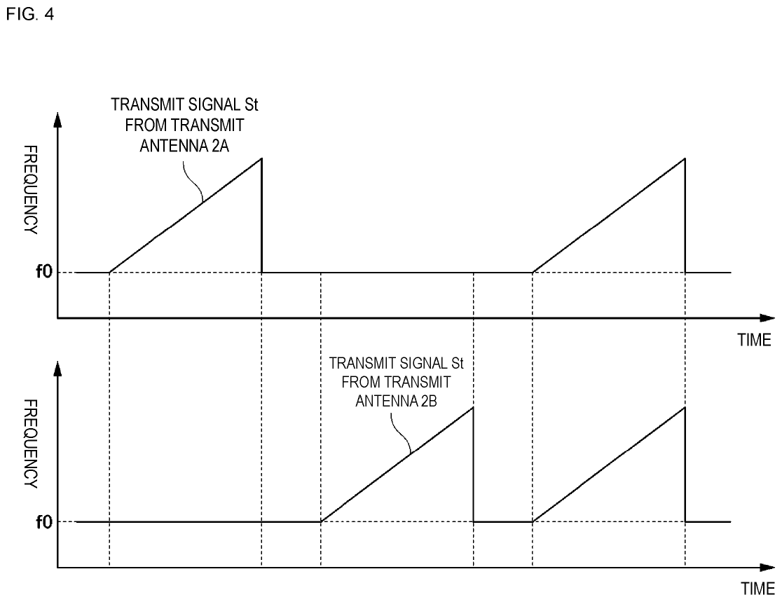

In step S1 in FIG. 5, a transmit signal St is sent from the transmit antenna 2A (see FIG. 4). In this case, the transmit antenna 2A corresponds to the virtual transmit antenna Tx1 (see FIG. 3). The transmit signal St sent from the transmit antenna Tx1 is reflected by a target and echo signals Se (reflected waves) are generated. In step S2, the echo signals Se returned from the target are received by the receive antennas 3A and 3B. In this case, the receive antennas 3A and 3B correspond to the virtual receive antennas Rx1 and Rx2. The signal processor 11 generates beat signals Sb based on the echo signals Se received by the receive antennas Rx1 and Rx2 and stores the generated beat signals Sb in the storage 11A.

In step S3, a transmit signal St is sent from the transmit antenna 2B (see FIG. 4). In this case, the transmit antenna 2B corresponds to the virtual transmit antenna Tx2 (see FIG. 3). The transmit signal St sent from the transmit antenna Tx2 is reflected by the target and echo signals Se are generated. In step S4, the echo signals Se returned from the target are received by the receive antennas 3A and 3B. In this case, the receive antennas 3A and 3B correspond to the virtual receive antennas Rx3 and Rx4. The signal processor 11 generates beat signals Sb based on the echo signals Se received by the receive antennas Rx3 and Rx4 and stores the generated beat signals Sb in the storage 11A.

In step S5, in-phase transmit signals St are simultaneously sent from the transmit antennas 2A and 2B (see FIG. 4). In this case, the transmit antennas 2A and 2B correspond to the virtual transmit antenna Tx3 (see FIG. 3). The transmit signal St sent from the transmit antenna Tx3 is reflected by the target and echo signals Se are generated. In step S6, the echo signals Se returned from the target are received by the receive antennas 3A and 3B. In this case, the receive antennas 3A and 3B correspond to the virtual receive antennas Rx5 and Rx6. The signal processor 11 generates beat signals Sb based on the echo signals Se received by the receive antennas Rx5 and Rx6 and stores the generated beat signals Sb in the storage 11A.

In step S7, the signal processor 11 calculates the direction in which the target is located (angle θ with respect to the Y direction), based on the beat signals Sb stored in the storage 11A. At this time, the beat signals Sb based on the echo signals Se received by the receive antennas Rx1 through Rx6 are stored in the storage 11A. The signal processor 11 estimates the angle θ, based on the phase differences among the six beat signals Sb, for example. After step S7, the processing is repeated from step S1.

The transmit antennas Tx1 through Tx3 send transmit signals St in a time division manner. The sending order of the transmit signals St from the transmit antennas Tx′ through Tx3 is not restricted to that described above. For example, one of the transmit antennas Tx2 and Tx3 may send a transmit signal St first, and then, one of the transmit antennas Tx1 and Tx3 may send a transmit signal St next time. Every time the sending of transmit signals St from the transmit antennas Tx1 through Tx3 is repeated, the sending order may be changed.

When the signal processor 11 has executed the above-described target direction finding processing, it estimates the target angle in the following manner. After a transmit signal St is radiated from each of the transmit antennas Tx1 through Tx3, reflected waves (echo signals Se) from the target are received by the receive antennas Rx1 through Rx6. The echo signals Se are each mixed with the transmit wave (local signal SL) so as to output beat signals Sb each having the frequency indicating the difference between the corresponding echo signal Se and the local signal SL. The beat signals Sb are subjected to A/D conversion by the group of beat signals Sb for each of the transmit antennas Tx1, Tx2, and Tx3. The signal processor 11 executes signal processing on the beat signals Sb by FFT, for example, and estimates the distance to the target and the angle θ of the target, based on the processed beat signals Sb. The signal processor 11 estimates the angle of the target, based on the beat signals Sb for each of the transmit antennas Tx1 through Tx3, that is, the three groups of beat signals Sb. The present disclosure is not restricted to the above-described angle estimation. Angle estimation may be repeated multiple times as a result of sending transmit signals St from the three transmit antennas Tx1 through Tx3 multiple times.

FIG. 1 shows an example in which the transmit antennas 2A and 2B are separated from each other with a spacing twice (2λ) as long as the wavelength λ. When transmit signals St are simultaneously sent from the transmit antennas 2A and 2B, the phase center of the composite wave of the transmit signals St is positioned at the center between the two transmit antennas 2A and 2B. This is equivalent to the configuration in which the virtual transmit antennas Tx1 through Tx3 are disposed with a spacing of the wavelength λ, as shown in FIG. 3.

The phase differences among the signals received by the receive antennas 3A and 3B based on the combinations of the transmit antennas Tx1 through Tx3 and the receive antennas 3A and 3B are subjected to the Kronecker product operation. This is equivalent to the configuration in which the virtual receive antennas Rx1 through Rx6 are disposed. The receive antennas Rx1 through Rx6 are disposed at equal spacings of 0.5λ.

When the receive antennas Rx1 through Rx6 are disposed at equal spacings of 0.5λ, the angular resolution of the arrival wave is calculated as 2/N [rad] where N is the element number of receive antennas Rx1 through Rx6. In the related art, transmit signals are not simultaneously sent from the transmit antennas 2A and 2B, and instead, a transmit signal is only sent individually from the transmit antennas 2A and 2B. With the use of the transmit antennas 2A and 2B and the receive antennas 3A and 3B, the element number N of virtual receive antennas Rx1 through Rx4 thus results in four.

In contrast, in this embodiment, in addition to sending of a transmit signal individually from the transmit antennas 2A and 2B, transmit signals are simultaneously sent from the transmit antennas 2A and 2B. Accordingly, the element number N of virtual receive antennas Rx1 through Rx6 results in six. The angular resolution thus becomes 1.5 times as high as that of the related art without necessarily the need to increase the number of actual transmit antennas 2A and 2B and that of receive antennas 3A and 3B.

As described above, in the radar device 1 of this embodiment, the transmit processor 6 sends transmit signals St which are separable from each other from the two transmit antennas 2A and 2B, and also simultaneously sends transmit signals St which are combinable with each other from the two transmit antennas 2A and 2B.

More specifically, when sending transmit signals St which are separable from each other from the two transmit antennas 2A and 2B, the transmit processor 6 sends a transmit signal St from the transmit antenna 2A and that from the transmit antenna 2B at different timings.

In the radar device 1, the two transmit antennas 2A and 2B are sequentially switched to send a transmit signal St, and also, the two transmit antennas 2A and 2B send transmit signals St simultaneously. When the transmit signals St simultaneously sent from the two transmit antennas 2A and 2B are in-phase signals, the phase center of the radio wave (composite wave) obtained by combining these transmit signals in the air is the center between the two transmit antennas 2A and 2B. This means that, with the use of the two transmit antennas 2A and 2B, the phase center of the transmit signal St is located at a total of three positions, that is, the position of the transmit antenna 2A, the position of the transmit antenna 2B, and the center position between the transmit antennas 2A and 2B. This is equivalent to the configuration in which the three virtual transmit antennas Tx1 through Tx3 are disposed.

Typically, in a MIMO radar device, the number of receive antennas in a virtual array antenna is determined by the product of the number of transmit antennas and that of receive antennas. In this embodiment, more virtual transmit antennas Tx1 through Tx3 than the actual transmit antennas 2A and 2B can be provided. In this embodiment, more receive antennas Rx1 through Rx6 can thus be provided in the virtual array antenna without necessarily increasing the number of actual circuits. It is thus possible to enhance the angular resolution when the direction of arrival of echo signals Se is estimated.

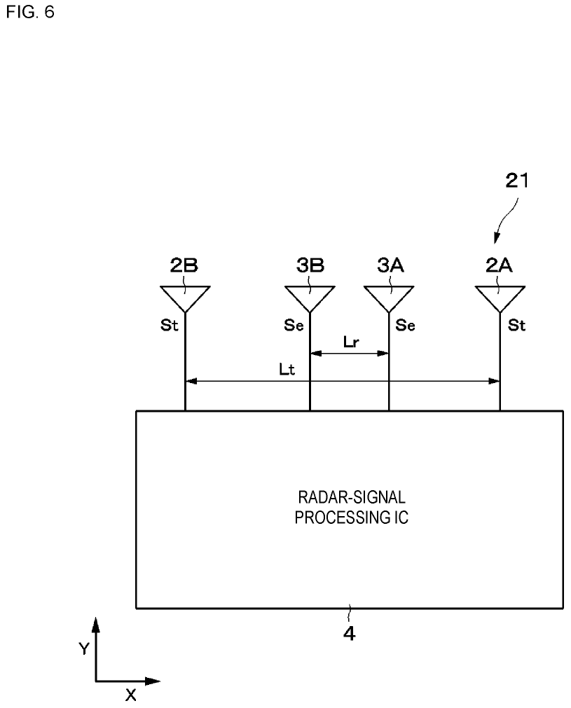

A second embodiment of the present disclosure will be described below with reference to FIG. 6. In the second embodiment, receive antennas are disposed between plural transmit antennas. In the second embodiment, the same elements as those of the first embodiment are designated by like reference numerals and an explanation thereof will be omitted.

In a manner similar to the radar device 1 of the first embodiment, a radar device 21 of the second embodiment includes transmit antennas 2A and 2B, receive antennas 3A and 3B, and a radar-signal processing IC 4.

In the second embodiment, however, the receive antennas 3A and 3B are disposed between the two transmit antennas 2A and 2B. The transmit antennas 2A and 2B are disposed with a predetermined spacing Lt therebetween in the X direction. The spacing Lt is set to be a value (2λ) twice as long as the wavelength λ of a transmit signal St, for example. The receive antennas 3A and 3B are disposed with a predetermined spacing Lr therebetween in the X direction. The spacing Lr is set to be a value (0.5λ), which is half the wavelength λ of the transmit signal St, for example. The transmit antennas 2A and 2B and the receive antennas 3A and 3B may not be necessarily aligned, and may be displaced from each other in the Y direction, which is perpendicular to the X direction.

In the second embodiment configured as described above, advantages similar to those of the first embodiment are achieved. In the second embodiment, since the receive antennas 3A and 3B are disposed between the two transmit antennas 2A and 2B, the area occupied by the transmit antennas 2A and 2B and the receive antennas 3A and 3B can be reduced. This can decrease the size of the entire radar device 21.

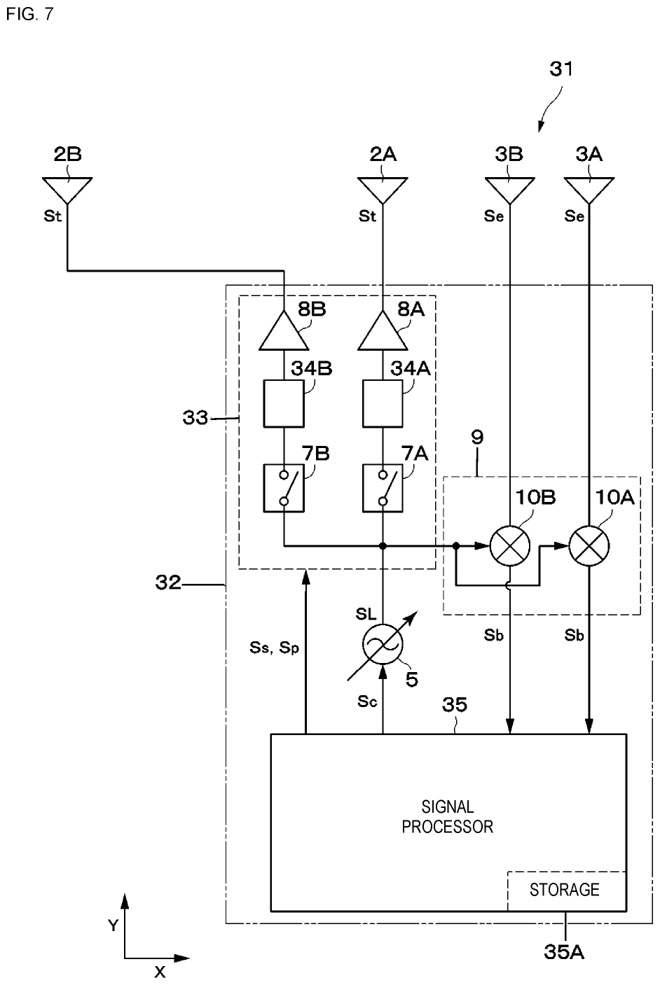

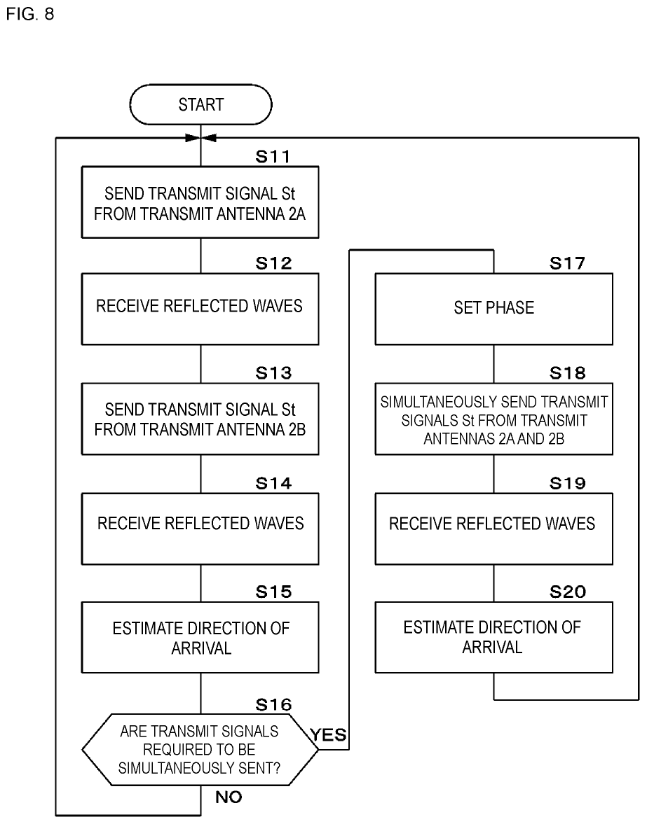

A third embodiment of the present disclosure will be described below with reference to FIGS. 7 and 8. In the third embodiment, when transmit signals are individually sent from the transmit antennas, the signal processor estimates the direction of arrival of echo signals. In the third embodiment, the same elements as those of the first embodiment are designated by like reference numerals and an explanation thereof will be omitted.

In a manner similar to the radar device 1 of the first embodiment, a radar device 31 of the third embodiment includes transmit antennas 2A and 2B, receive antennas 3A and 3B, and a radar-signal processing IC 32. The radar-signal processing IC 32 is configured similarly to the radar-signal processing IC 4 of the first embodiment and includes a local oscillator 5, a transmit processor 33, a receive processor 9, and a signal processor 35.

The transmit processor 33 executes processing for sending a local signal SL output from the local oscillator 5 from the transmit antennas 2A and 2B as transmit signals St. The transmit processor 33 includes switches 7A and 7B, power amplifiers 8A and 8B, and phase shifters 34A and 34B. The phase shifters 34A and 34B are respectively connected between the switches 7A and 7B and the power amplifiers 8A and 8B. The phase shifters 34A and 34B adjust the phase of the local signal SL, based on a phase control signal Sp output from the signal processor 35. Accordingly, transmit signals St to be sent from the transmit antennas 2A and 2B may be in phase with each other or out of phase from each other.

The signal processor 35 is configured similarly to the signal processor 11 of the first embodiment. The signal processor 35 includes a storage 35A. In the storage 35A, a program for direction finding processing shown in FIG. 8 is stored. The signal processor 35 executes this program stored in the storage 35A. The storage 35A stores beat signals Sb generated in the following cases in which: a transmit signal St is sent from the transmit antenna 2A; a transmit signal St is sent from the transmit antenna 2B; and transmit signals St are simultaneously sent from the transmit antennas 2A and 2B.

The signal processor 35 outputs a chirp control signal Sc to the local oscillator 5. The signal processor 35 outputs a switching control signal Ss, which controls the outputting of a transmit signal St, and the phase control signal Sp to the transmit processor 33. The signal processor 35 also measures the distance to a target (ranging) and finds the direction of the target by using the beat signals Sb output from the receive processor 9.

Target direction finding processing executed by the signal processor 35 will be described below with reference to FIG. 8.

In step S11 in FIG. 8, a transmit signal St is sent from the transmit antenna 2A. In this case, the transmit antenna 2A corresponds to the virtual transmit antenna Tx1 (see FIG. 3). The transmit signal St sent from the transmit antenna Tx1 is reflected by a target and echo signals Se (reflected waves) are generated. In step S12, the echo signals Se returned from the target are received by the receive antennas 3A and 3B. In this case, the receive antennas 3A and 3B correspond to the virtual receive antennas Rx1 and Rx2. The signal processor 35 generates beat signals Sb based on the echo signals Se received by the receive antennas Rx1 and Rx2 and stores the generated beat signals Sb in the storage 35A.

In step S13, a transmit signal St is sent from the transmit antenna 2B. In this case, the transmit antenna 2B corresponds to the virtual transmit antenna Tx2 (see FIG. 3). The transmit signal St sent from the transmit antenna Tx2 is reflected by the target and echo signals Se are generated. In step S14, the echo signals Se returned from the target are received by the receive antennas 3A and 3B. In this case, the receive antennas 3A and 3B correspond to the virtual receive antennas Rx3 and Rx4. The signal processor 35 generates beat signals Sb based on the echo signals Se received by the receive antennas Rx3 and Rx4 and stores the generated beat signals Sb in the storage 35A.

In step S15, the signal processor 35 calculates the direction in which the target is located (angle θ with respect to the Y direction), based on the beat signals Sb stored in the storage 35A. At this time, the beat signals Sb based on the echo signals Se received by the receive antennas Rx1 through Rx4 are stored in the storage 35A. The signal processor 35 estimates the angle θ, based on the phase differences among the four beat signals Sb, for example.

In step S16, the signal processor 35 judges whether to simultaneously send transmit signals St from the transmit antennas 2A and 2B. If no target is detected in step S15, it is optional to improve the precision of the angle θ. In this case, the signal processor 35 judges that the result of step S16 is “NO” and repeats the processing from step S11.

If a target is detected in step S15, it is suitable to improve the precision of the angle θ. The signal processor 35 thus judges that the result of step S16 is “YES” and proceeds to step S17.

In step S17, the phase of a transmit signal St to be sent from the transmit antenna 2A and that from the transmit antenna 2B are set, based on the detection result of a target in step S15, that is, the estimation result of the direction of arrival of the echo signals Se. For example, if plural targets are detected in step S15, some of them may not be required to be detected, and some of them may currently be automatically tracked. Hence, targets that are not required to be detected are excluded, and then, the phases of transmit signals St are adjusted so that the resulting transmit signals St are radiated from the transmit antennas 2A and 2B toward a target to be detected.

In step S18, in-phase transmit signals St are simultaneously sent from the transmit antennas 2A and 2B. When the transmit signals St are simultaneously sent from the transmit antennas 2A and 2B, the radiation directions of the transmit signals St are adjusted in accordance with the phases of the transmit signals St. The transmit antennas 2A and 2B correspond to the virtual transmit antenna Tx3 (see FIG. 3). The transmit signals St sent from the transmit antenna Tx3 are reflected by the target and echo signals Se are generated. In step S19, the echo signals Se returned from the target are received by the receive antennas 3A and 3B. In this case, the receive antennas 3A and 3B correspond to the virtual receive antennas Rx5 and Rx6. The signal processor 35 generates beat signals Sb based on the echo signals Se received by the receive antennas Rx5 and Rx6 and stores the generated beat signals Sb in the storage 35A.

In step S20, the signal processor 35 calculates the direction in which the target is located (angle θ with respect to the Y direction), based on the beat signals Sb stored in the storage 35A. At this time, the beat signals Sb based on the echo signals Se received by the receive antennas Rx1 through Rx6 are stored in the storage 35A. The signal processor 35 estimates the angle θ, based on the phase differences among the six beat signals Sb, for example. After step S20, the processing is repeated from step S11.

In the third embodiment configured as described above, advantages similar to those of the first embodiment are achieved. In the third embodiment, when transmit signals St are sent individually from the transmit antennas 2A and 2B, the signal processor 35 estimates the direction of arrival of echo signals Se. If a target is not detected, processing for simultaneously sending transmit signals St from the transmit antennas 2A and 2B can be omitted. Hence, the calculation time and power consumption required by the signal processor 35 can be reduced.

When simultaneously sending transmit signals St from the two transmit antennas 2A and 2B, the transmit processor 33 provides a phase difference between the two transmit signals St to be sent from the two transmit antennas 2A and 2B, based on the estimation result of the direction of arrival. It is thus possible to tilt the direction of the composite wave, which is generated by combining the two transmit signals St, with respect to the Y direction, for example, in accordance with the phase difference. With this configuration, even when the half power beamwidth regarding the directivity of the composite wave becomes narrow, the directivity can be adjusted. The composite wave (transmit signals St) can thus be radiated to a target to be subjected to direction finding.

In the above-described embodiments, when sending transmit signals St which are separable from each other from the two transmit antennas 2A and 2B, they are sent from the two transmit antennas 2A and 2B at different timings. The present disclosure is not restricted to this configuration. For example, when sending two transmit signals orthogonal to each other from the two transmit antennas 2A and 2B, they may be sent simultaneously from the transmit antennas 2A and 2B and are yet separable from each other. Transmit signals orthogonal to each other may be a horizontally polarized signal and a vertically polarized signal or signals modulated by orthogonal codes.

In the above-described embodiments, the transmit antennas 2A and 2B and the receive antennas 3A and 3B are each constituted by a single antenna element. The present disclosure is not restricted to this configuration. Transmit antennas and receive antennas may be each constituted by an array antenna including plural antenna elements.

In the above-described embodiments, the radar devices 1, 21, and 31, each estimates the position of a target in a two-dimensional plane by way of example. The disclosure may be applicable to a radar device that estimates the position of a target in a three-dimensional space.

Specific numeric values discussed in the above-described embodiments are only examples and are not limited to these values. The numeric values are suitably set in accordance with the specification of a device to which the disclosure is applied.

The above-described embodiments are only examples. The configurations described in different embodiments may partially be replaced by or combined with each other.

The disclosure discussed through illustration of the above-described embodiments will be described below. The present disclosure provides a radar device including plural transmit antennas, at least one receive antenna, a local oscillator that oscillates a local signal, a transmit processor that sends transmit signals based on the local signal from the transmit antennas, a receive processor that outputs beat signals from the local signal and echo signals generated as a result of the transmit signals being reflected by a target and received by the at least one receive antenna, and a signal processor that executes signal processing on the beat signals. The transmit processor sends the transmit signals which are separable from each other from the plural transmit antennas and also simultaneously sends the transmit signals which are combinable with each other from the plural transmit antennas.

With this configuration, the phase center of the composite wave obtained by combining in the air transmit signals simultaneously sent from the plural transmit antennas is the center between the plural transmit antennas. As a result, more virtual transmit antennas than the number of actual transmit antennas can be provided, and a greater number of receive antennas can be provided in a virtual array antenna without necessarily increasing the number of actual circuits. It is thus possible to enhance the angular resolution when the direction of arrival of echo signals is estimated.

In the present disclosure, when sending the transmit signals which are separable from each other from the plural transmit antennas, the transmit processor sends the transmit signals from the plural transmit antennas at different timings. This makes it possible to send transmit signals from the plural transmit antennas in a time division manner and to make these transmit signals separable from each other.

In the present disclosure, the at least one receive antenna is disposed between the plural transmit antennas. This makes it possible to reduce the area occupied by the transmit antennas and the receive antennas, thereby decreasing the size of the entire radar device.

In the present disclosure, the signal processor estimates a direction of arrival of the echo signals when the transmit signals are individually sent from the transmit antennas. If a target is not detected, processing for simultaneously sending transmit signals from the plural transmit antennas can be omitted. This can reduce the calculation time and power consumption required by the signal processor.

In the present disclosure, when simultaneously sending the transmit signals from the plural transmit antennas, the transmit processor provides a phase difference between the plural transmit signals to be simultaneously sent from the plural transmit antennas, based on an estimation result of the direction of arrival.

The direction of the composite wave generated by combining plural transmit signals can be adjusted in accordance with a phase difference. Even when the half power beamwidth regarding the directivity of the composite wave becomes narrow, the directivity can be adjusted, and the composite wave can be radiated to a target to be subjected to direction finding.

### REFERENCE SIGNS LIST

1, 21, 31 radar device
2A, 2B transmit antenna
3A, 3B receive antenna
4, 32 radar-signal processing IC
5 local oscillator
6, 33 transmit processor
9 receive processor
11, 35 signal processor

1. A radar device comprising:
a plurality of transmit antennas;
at least one receive antenna;
a local oscillator configured to output a local signal;
a transmit processor configured to send transmit signals from the transmit antennas based on the local signal;
a receive processor configured to output beat signals from the local signal and echo signals, the echo signals being generated as a result of the transmit signals being reflected by a target and received by the at least one receive antenna; and
a signal processor configured to process the beat signals,
wherein the transmit processor is configured to send the transmit signals as separate transmit signals from the plurality of transmit antennas, and to simultaneously send the transmit signals as a composite signal from the plurality of transmit antennas, and
wherein the plurality of transmit antennas have a same directivity.

2. The radar device according to claim 1, wherein, when sending the transmit signals as separate transmit signals, the transmit processor is configured to send the transmit signals from the plurality of transmit antennas at different timings.

3. The radar device according to claim 1, wherein the at least one receive antenna is physically arranged between the plurality of transmit antennas.

4. The radar device according to claim 2, wherein the at least one receive antenna is physically arranged between the plurality of transmit antennas.

5. The radar device according to claim 1, wherein the signal processor is configured to estimate a direction of arrival of the echo signals when the transmit signals are separately sent from the transmit antennas.

6. The radar device according to claim 2, wherein the signal processor is configured to estimate a direction of arrival of the echo signals when the transmit signals are separately sent from the transmit antennas.

7. The radar device according to claim 3, wherein the signal processor is configured to estimate a direction of arrival of the echo signals when the transmit signals are separately sent from the transmit antennas.

8. The radar device according to claim 5, wherein, when simultaneously sending the transmit signals as the composite signal, the transmit processor is configured to provide a phase difference between the plurality of transmit signals based on the estimated direction of arrival.

9. The radar device according to claim 6, wherein, when simultaneously sending the transmit signals as the composite signal, the transmit processor is configured to provide a phase difference between the plurality of transmit signals based on the estimated direction of arrival.

10. The radar device according to claim 7, wherein, when simultaneously sending the transmit signals as the composite signal, the transmit processor is configured to provide a phase difference between the plurality of transmit signals based on the estimated direction of arrival.

11. The radar device according to claim 5, wherein:
when no direction of arrival is estimated, the transmit processor is configured to re-send the transmit signals separately;
when the direction of arrival is estimated, the signal processor determines whether to improve a precision of the estimated direction of arrival; and
when the signal processor determines to improve the precision, the transmit processor is configured to send the transmit signals as the composite signal and the signal processor is configured to improve the precision of the estimated direction of travel based on the echo signals of the transmit signals sent as the composite signal.

12. The radar device according to claim 6, wherein:
when no direction of arrival is estimated, the transmit processor is configured to re-send the transmit signals separately;
when the direction of arrival is estimated, the signal processor determines whether to improve a precision of the estimated direction of arrival; and
when the signal processor determines to improve the precision, the transmit processor is configured to send the transmit signals as the composite signal and the signal processor is configured to improve the precision of the estimated direction of travel based on the echo signals of the transmit signals sent as the composite signal.

13. The radar device according to claim 7, wherein:
when no direction of arrival is estimated, the transmit processor is configured to re-send the transmit signals separately;
when the direction of arrival is estimated, the signal processor determines whether to improve a precision of the estimated direction of arrival; and
when the signal processor determines to improve the precision, the transmit processor is configured to send the transmit signals as the composite signal and the signal processor is configured to improve the precision of the estimated direction of travel based on the echo signals of the transmit signals sent as the composite signal.
